(19) United States
(12) Patent Application Publication
(10) Pub. No.: US 2006/0099306 A1
(43) Pub. Date: May 11, 2006

(54) Packaging for use with high pressure pasteurization

(75) Inventor: Daniel S. Miller, Austin, MN (US)

Correspondence Address: IPLM GROUP, P.A., POST OFFICE BOX 18455, MINNEAPOLIS, MN, 55418, US

(73) Assignee: Hormel Foods, LLC

(21) Appl. No.: 11/184,467

(22) Filed: Jul. 19, 2005

Related U.S. Application Data
(60) Provisional application No. 60/625,920, filed on Nov. 8, 2004.

(51) Int. Cl. A23B 7/148; A23L 3/16

(52) U.S. Cl. 426/106; 426/521

(57) ABSTRACT

The invention provides, in one aspect, a method of packaging a product and treating the packaged product with high pressure pasteurization comprising placing a product within a package being water resistant, submerging the packaged product in water and applying pressure on the packaged product with water, and removing the packaged product from the water, wherein the packaged product has not been penetrated by water.

This application claims the benefit of U.S. Provisional Application No. 60/625,920, filed Nov. 8, 2004.

### FIELD OF THE INVENTION

The present invention relates to packaging for use with high pressure pasteurization.

### BACKGROUND OF THE INVENTION

Consumers desire high quality, minimally processed foods with fresh characteristics and little to no additives. High pressure pasteurization (“HPP”), also known as high hydrostatic pressure processing or ultra-high pressure processing, is being used to pasteurize foods at elevated pressures of approximately 30,000 to 130,000 pounds per square inch (“psi”) for a specified temperature and time. The pressure is applied through a pressure medium such as a liquid or a gas. Under these conditions, HPP has been found to be effective in inactivating many pathogenic microorganisms commonly found in foods. As compared to canned foods or pasteurized juices and milk, HPP significantly reduces the process temperature and time, which results in foods with improved characteristics such as better retention of freshness, flavor, texture, color, and nutrients.

HPP is based on the Le Chatelier principle which states that a system at equilibrium adjusts when subjected to a stress and that actions that have a net volume increase will be retarded and actions that have a net volume decrease will be enhanced. HPP utilizes isostatic or hydrostatic pressure which is equal from every direction. Isostatic compression transfers pressure instantly and uniformly throughout the pressure medium providing a non-thermal process alternative for the pasteurization of temperature-sensitive foods. Foods suspended in the pressure medium are assumed to follow the isostatic principle. The basis for using the HPP process as a pasteurization method is based on the assumption that the product also follows the isostatic rule, which states that isostatic pressure is instantly and uniformly transmitted throughout the pressurized medium and the enclosed food product, regardless of size, shape or physical state of the food.

During HPP, foods are subjected to pressures up to 130,000 psi, and the pressure destroys pathogenic microorganisms by interrupting their cellular functions. Within a living bacteria cell, many pressure sensitive processes such as protein function, enzyme action, and cellular membrane function are impacted by high pressure resulting in the inability of the bacteria to survive. Small macromolecules that are responsible for flavor, order, and nutrition are typically not changed by pressure.

HPP is gaining in popularity within the food industry because of its capacity to inactivate pathogenic microorganisms with little to no heat treatment, resulting in the retention of most of the nutritional and sensory characteristics of fresh foods without sacrificing shelf-life of the foods.

One of the advantages of HPP is that pressure transmission is relatively instantaneous and uniform, and HPP is not controlled by product size and is effective throughout the foods. HPP also offers several advantages over traditional thermal processing including reduced process times, minimal heat damage, and retention of freshness, flavor, texture, color, and nutrients.

### SUMMARY OF THE INVENTION

The invention provides, in one aspect, a product packaging for use with high pressure pasteurization processing. The product packaging includes an upper web, a lower web, a first seal, a zipper member, an annular head space, and an area. The upper web and the lower web each have a perimeter and a top portion. The first seal connects the upper web and the lower web proximate the perimeters and releasably seals the perimeters of the upper web and the lower web together. The zipper member has a first portion and a second portion. The first portion and the second portion mate with one another and are releasably connectable. The first portion is operatively connected to the top portion of the upper web and the second portion is operatively connected to the top portion of the lower web. The zipper member interconnects the top portions of the upper web and the lower web. The annular head space is located between the upper web and the lower web and between the first seal and the zipper member. The area is located across the top portion of at least one of the upper web and the lower web proximate the annular head space and indicates where the at least one of the upper web and the lower web is to be opened. The first seal prevents moisture from entering the annular head space during high pressure pasteurization.

The invention provides, in another aspect, a product packaging for use with high pressure pasteurization processing. The packaging includes an upper web and a lower web each having a perimeter and a top portion. A first seal connects the upper web and the lower web proximate the perimeters and releasably seals the perimeters of the upper web and the lower web together. A zipper member includes a first portion and a second portion. The first portion and the second portion mate and releasably connect with one another. The first portion is operatively connected to the top portion of the upper web and the second portion is operatively connected to the top portion of the lower web. The zipper member interconnects the top portions of the upper web and the lower web. An annular head space is located between the upper web and the lower web and between the first seal and the zipper member. A score line extends across the top portion of at least one of the upper web and the lower web proximate the annular head space. The score line is sealed and allows the at least one of the upper web and the lower web to be torn along the score line. The first seal and the score line prevent moisture from entering the annular head space during high pressure pasteurization.

The invention provides, in another aspect, a method of packaging a product and treating the packaged product with high pressure pasteurization comprising placing a product within a package being water resistant, submerging the packaged product in water and applying pressure on the packaged product with water, and removing the packaged product from the water, wherein the packaged product has not been penetrated by water.

The invention provides, in another aspect, a method of packaging a product and treating the packaged product with high pressure pasteurization. A product is placed within a package being water resistant. The package includes an upper web and a lower web each having a perimeter and a top portion. A first seal connects the upper web and the lower web proximate the perimeters and releasably seals the perimeters of the upper web and the lower web together. A zipper member has a first portion and a second portion which mate with one another and are releasably connectable. The first portion is operatively connected to the top portion of the upper web and the second portion is operatively connected to the top portion of the lower web. The zipper member interconnects the top portions of the upper web and the lower web. An annular head space is between the upper web and the lower web and between the first seal and the zipper member. A score line extends across the top portions of the upper web and the lower web proximate the annular head space, and the score line is sealed and allows the upper web and the lower web to be torn along the score line. The first seal and the score line prevent moisture from entering the annular head space during high pressure pasteurization. The packaged product is submerged in water and pressure is applied on the packaged product with water. The packaged product is removed from the water, wherein the packaged product has not been penetrated by water.

### BRIEF DESCRIPTION OF THE DRAWINGS

FIG. 1 is a top perspective view of a packaging constructed according to the principles of the present invention;

FIG. 2 is a top view of a single package of the packaging shown in FIG. 1;

FIG. 3 is a top view of the packaging shown in FIG. 1;

FIG. 4 is a top view of the packaging shown in FIG. 1;

FIG. 5 is a cross section of a top portion of a single package of the packaging shown in FIG. 1;

FIG. 6 is a top perspective view of another packaging constructed according to the principles of the present invention;

FIG. 7 is a top view of a single package of the packaging shown in FIG. 6;

FIG. 8 is a cross section of a top portion of a single package of the packaging shown in FIG. 6;

FIG. 9 is a top view of the packaging shown in FIG. 6; and

FIG. 10 is a top view of the packaging shown in FIG. 6.

### DETAILED DESCRIPTION OF A PREFERRED EMBODIMENT

A preferred packaging assembly for use with high pressure pasteurization (“HPP”) constructed according to the principles of the present invention is designated by the numerals 100 and 200 in the drawings.

Foods such as processed meats and cheeses are commonly packaged and sold to consumers in packages made of flexible thermoplastic web materials. Typically, the foods are contained between two layers of web, and the two layers of web are sealed together proximate the perimeter of the package to hermetically seal the foods between the two layers of web. Prior art packages include perforations through at least one layer of web along at least one side of the package proximate the seal to allow the at least one side of the package to be readily opened by the consumers. Preferably, both layers of web are perforated so that a strip of web may be torn off of the package thereby tearing off the seal along the at least one side to create an opening in the package. Proximate the at least one side of the package including perforations, a closure such as an interlocking closure strip is commonly included to re-seal the two layers of web after the package has been opened. An annular head space is located between the two layers of web between the closure and the seal proximate the at least one side of the package. Prior art packages also include peg holes through which pegs are inserted for displaying the packaged foods. The peg holes are aligned apertures in the two layers of web preferably proximate a top portion of the package. Commonly, the peg holes are located within the annular head space of the package.

When the prior art packages are processed using HPP, for example HPP using water as the pressure medium, water penetrates the packages through any openings in the packages. More specifically, water penetrates the packages through the perforations along at least one side of the packages and through the peg holes. Water then becomes trapped between the two layers of web within the annular head space. Not only is the trapped water aesthetically displeasing to consumers, but the water present in the annular head space of the package may be perceived by the consumers as a defect. In addition, the trapped water may also become a breading ground for pathogenic microorganisms that could contaminate the foods when the packages are opened. Therefore, it is desired to prevent water or moisture from penetrating the packages during HPP, which is addressed by the present invention.

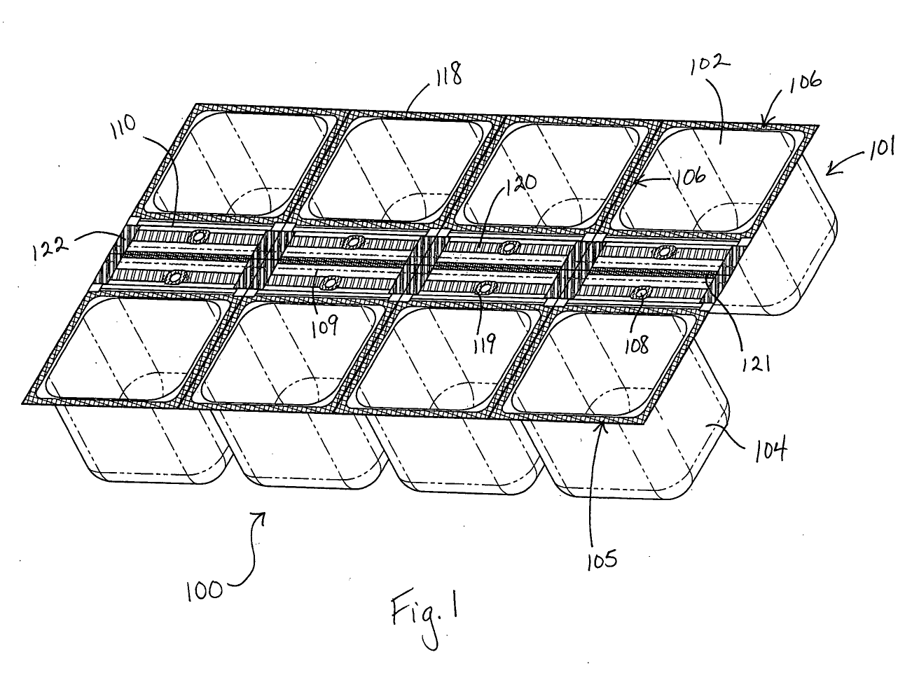

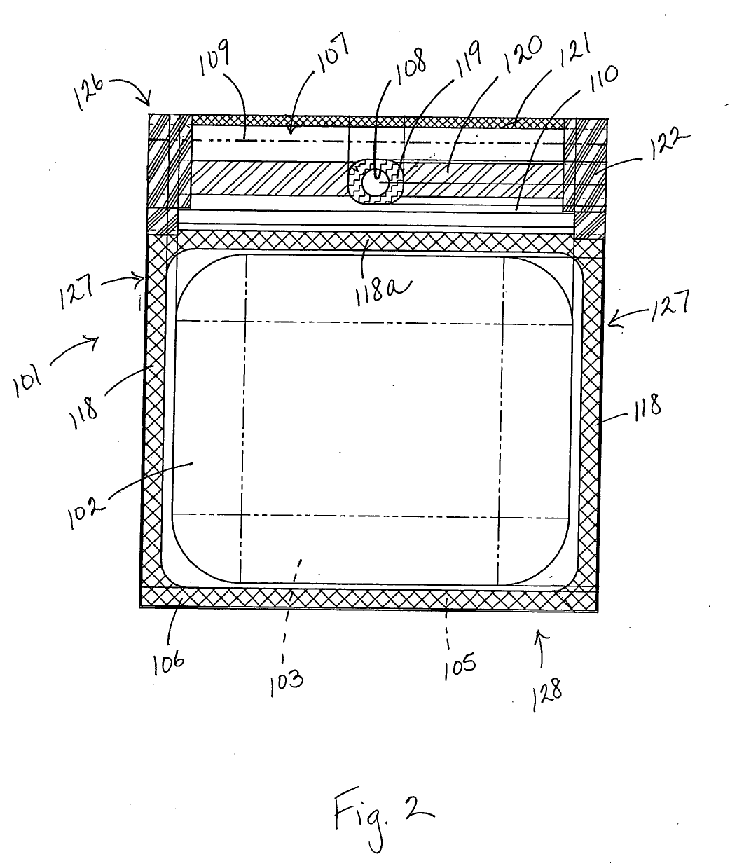

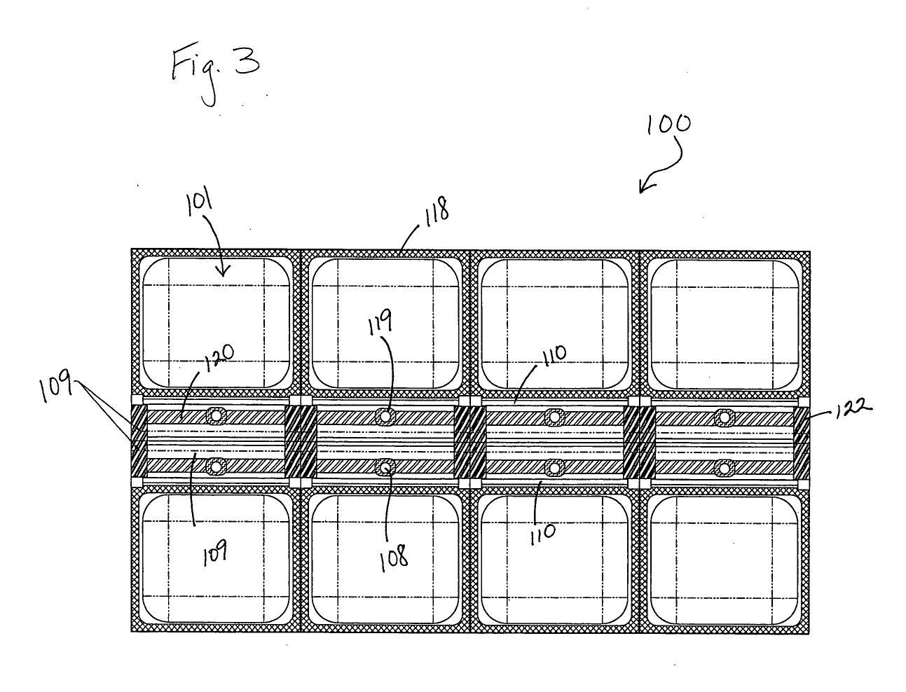

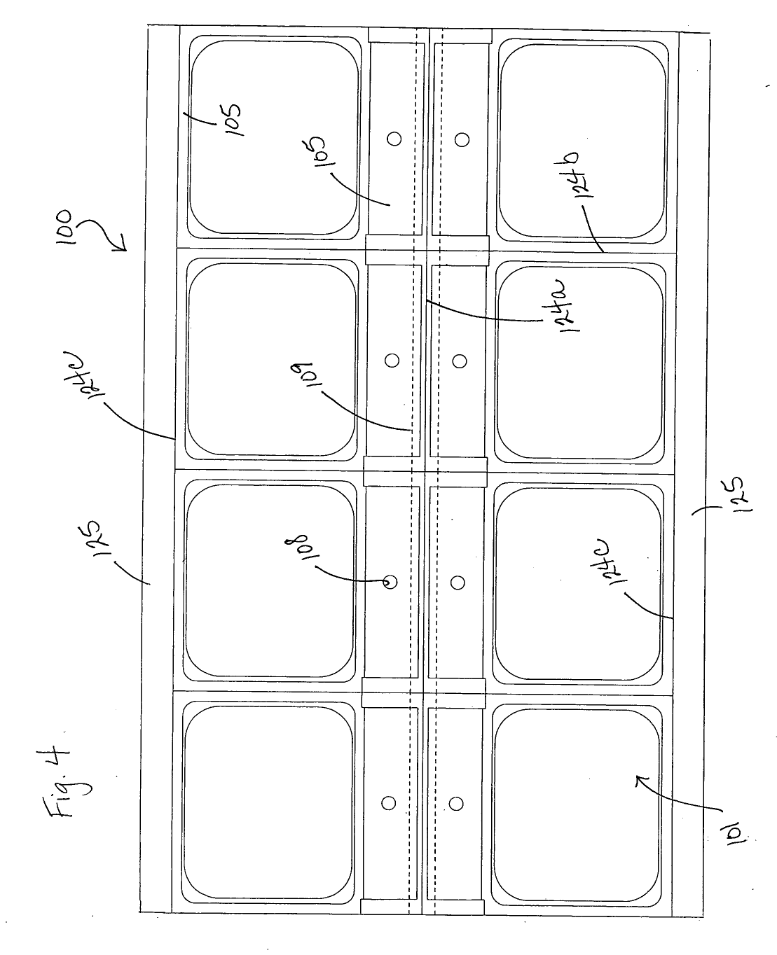

A packaging assembly 100 is shown in FIGS. 1, 3, and 4. The packaging assembly 100 includes a plurality of single packages 101 interconnected for the ease of manufacture. The single packages 101 are separated by cutting along lines 124a, 124b, and 124c which represent where the packaging assembly 100 is cut to allow for the separation of each package 101. A single package 101 is shown in FIG. 2. Each package 101 includes a top portion 126, sides 127, and a bottom portion 128. A row of packages 101 are interconnected proximate the sides 127 of the packages 101, and two rows of packages 101 are interconnected proximate the top portions 126 of the packages 101. A machining flange 125 is connected along the bottom portions 128 of the packages 101. Lines 124c along the bottom portions of the single packages 101 represent where the machining flanges 125 are separated from the bottom portions 128 of the single packages 101, line 124a between the top portions 126 of the single packages 101 proximate the longitudinal axis of the packaging assembly 100 represents where the two rows of packages 101 are separated, and lines 124b between the side portions of the single packages 101 represent where the adjacent packages 101 are separated.

Each package 101 includes an upper web 102 and a lower web 103. The upper and lower webs 102 and 103 are preferably flexible packaging film, which is well known in the art. More preferably, the upper web 102 is a non-forming film with an easy-peel layer and the lower web 103 is a forming film. An easy-peel layer is well known in the art, and it is a layer in the film that allows the two layers of web to be separated after they have been heat sealed together. The easy-peel layer creates a weakened bond between the two layers of web. The lower web 103 includes a compartment portion 104 in which foods are contained and a flange portion 105 to which the upper web 102 is operatively connected proximate a perimeter 106 of the upper web 102 and the single package 101. The flange portion 105 is preferably larger proximate the top portion 126 of each package 101.

The perimeter 106 of the upper web 102 and the flange portion 105 of the lower web 103 are releasably interconnected by several seals, preferably heat seals of the easy-open or peel-away type. Releasably interconnecting two layers of web with a heat seal of the easy-open or peel-away type is well known in the art. A seal 118 is placed proximate the sides 127 and the bottom portion 128 of each package 101, and a seal 121 is placed proximate the top portion 126 of each package 101.

Preferably proximate the seal 121 is a score line 109 along the top portion 126 of each package 101. The score line 109 is preferably a plurality of laser-scored perforations in at least one of the two layers of web that do not fully penetrate the at least one of the two layers of web. The score line 109 enables the package 101 to be easily torn open along the score line 109 thereby allowing the two layers of web 102 and 103 to be separated and allowing access to the compartment portion 104. Preferably, the lower web 103 is laser-scored with a plurality of perforations. If both layers of web 102 and 103 include score lines 109, a portion of the top portion 126 may be detached and removed when the package 101 is torn open along the score line 109. The seal 121 functions as a tamper resistant seal before the score line 109 is torn. Optionally, a scissors could be used to cut the package 101 along the top portion 126 or oriented forming film including a notch proximate the top portion 126 could be used to indicate where the package 101 can be torn along the top portion 126 to open the package 101. It is recognized that any suitable means for opening the package 101 proximate the top portion 126 of the package 101 could be used.

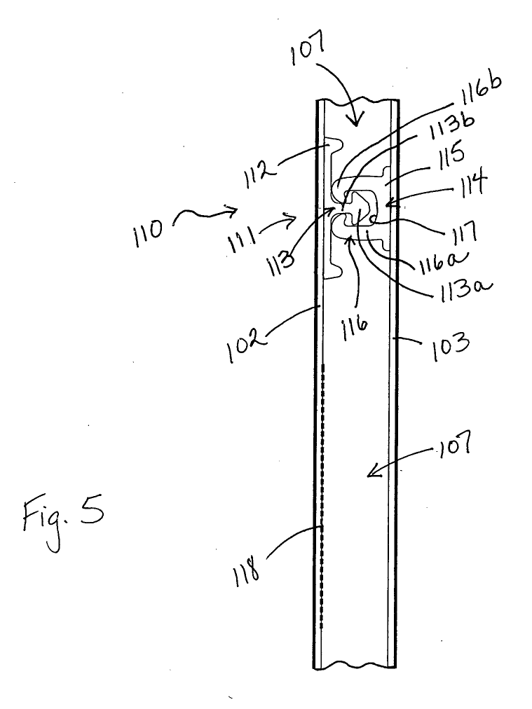

An optional closure 110 proximate the score line 109 is used to releasably interconnect the upper web 102 and the lower web 103 along the top portion 126 of the package 101 when the package 101 has been opened. The closure 110 is preferably an interlocking closure, commonly referred to as a zipper member, a cross section of which is shown in FIG. 5. The closure 110 includes a male portion 111 and a female portion 114. Although it does not matter to which layer of web the male portion 111 and the female portion 114 are operatively connected, the male portion 111 is shown operatively connected to the upper web 102 and the female portion 114 is shown operatively connected to the lower web 103.

The male portion 111 includes a connector 112 which operatively connects the male portion 111 to the upper web 102, and the female portion 114 includes a connector 115 which operatively connects the female portion 114 to the lower web 103. The respective portions of the closure 110 are preferably operatively connected to the web with heat seals as is well known in the art. The male portion 111 includes a plug member 113 having an arrow like cross section extending outward from the connector 112. The plug member 113 includes a top portion 113a and an intermediate portion 113b. The top portion 113a has a triangular cross section, and the intermediate portion 113b interconnects the connector 112 and the top portion 113a.

The female portion 114 includes a plug receiver 116 having two engaging members 116a extending outward proximate each longitudinal edge of the connector 115. The engaging members 116a include hook members 116b extending inward toward one another. A cavity 117 between the engaging members 116a is configured and arranged to receive the top portion 113a of the plug member 113, and the hook members 116b of the engaging members 116a are configured and arranged to engage the intermediate portion 113b. The engaging members 116a are pliable so as to deflect outward to allow insertion and withdrawal of the plug member 113 of the male portion 111 within and from the cavity 117 of the female portion 114 thereby releasably connecting the upper web 102 and the lower web 103. Seal 122 is used to secure the ends of the closure 110 to the sides 127 of the package 101 so that when the closure 110 is sealed the package 101 is also sealed.

An annular head space 107 is formed between the upper web 102 and the lower web 103 and between the seal 121 and the closure 110. A gas may optionally be included within the annular head space 107 but is not required. The score line 109 is placed within the annular head space 107, and a seal 120 is also placed within the annular head space 107 below the score line 109. The seal 120 preferably does not extend all the way up to the score line 109 so that the upper web 102 and the lower web 103 remain disconnected just below the score line 109. This enables the upper web 102 and the lower web 103 to be grasped and pulled apart in order to break the seal 120 and separate the layers to open the package 101. Each package 101 is hermetically sealed with the seals 118 and 120.

An optional aperture 108 may be used as a peg hole for displaying the package 101. Preferably, the aperture 108 is placed within the seal 120 and an additional seal 119 is placed proximate the circumference of the aperture 108 to ensure the package 101 is sealed. Because the closure 110 is located below the aperture 108, the aperture 108 does not interfere with the operation of the closure 110. An additional optional seal 118a may be placed between the closure 110 and the compartment portion 104, which is useful to reduce the amount of purge in contact with the closure 110 before the package 101 has been opened. Optional seal 118a is disclosed in U.S. Pat. No. 4,782,951, which is hereby incorporated by reference herein.

To initially open the package 101, the package 101 is preferably torn along the score line 109 thereby allowing the two layers of web 102 and 103 to be separated proximate the score line 109. Each layer of web 102 and 103 is pulled away from the other thereby pulling apart the seals 119 and 120. The seals 119 and 120 are peelable seals. The closure 110 is then pulled apart, the engaging members 116a of the female portion 114 deflecting outward to allow the plug member 113 of the male portion 111 to be withdrawn from the cavity 117 of the female portion 114 thereby releasing the male portion 111 from the female portion 114 and allowing the two layers of web 102 and 103 to be pulled apart. The seal 118a is then pulled apart. The seal 118a is also a peelable seal. The compartment portion 104 is then accessible through an opening between the two layers of web 102 and 103 proximate the top portion 126 of the package 101. The package may be re-sealed by mating the male portion 111 and the female portion 114 of the closure 110 together. To subsequently open and re-seal the package, the closure 110 is simply separated and then re-sealed.

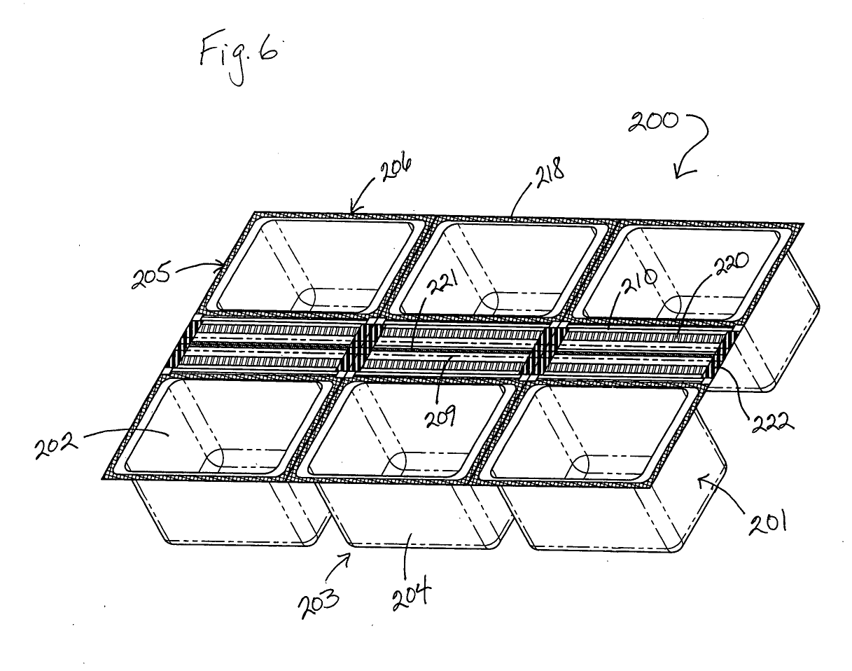

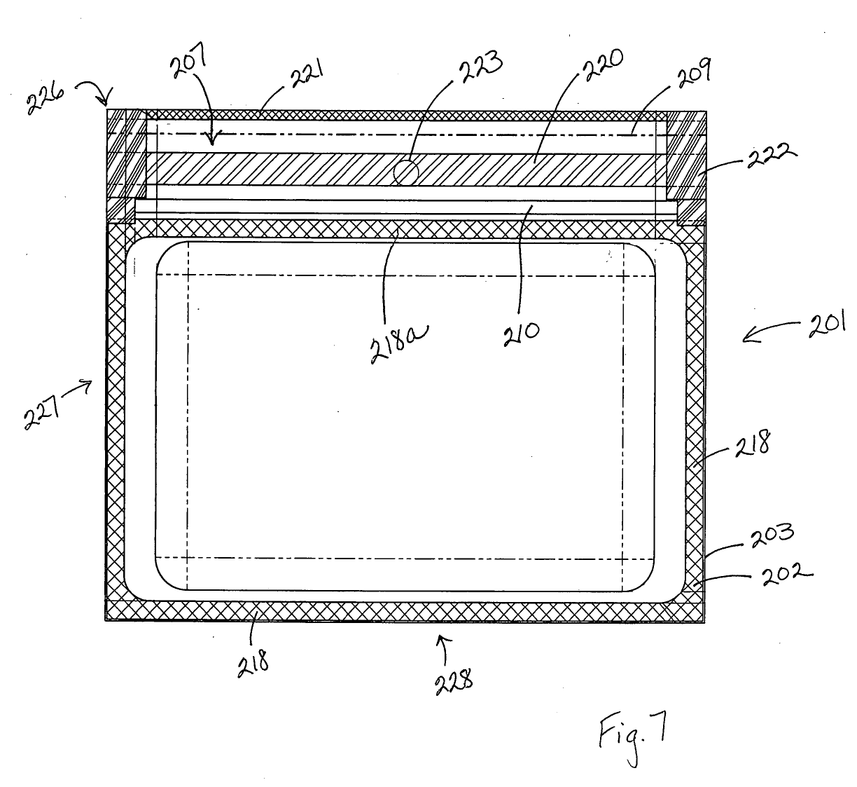

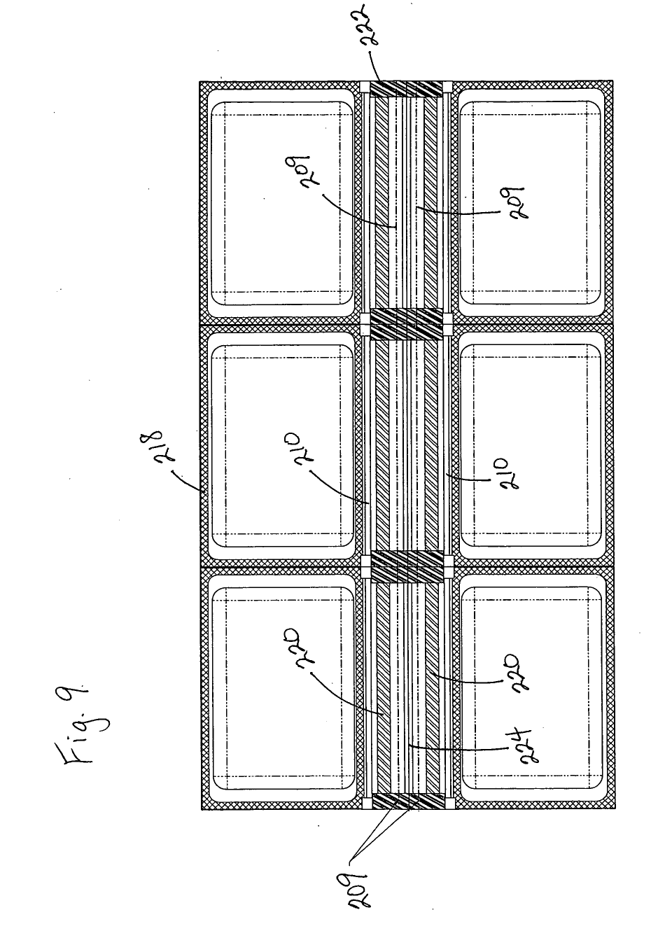

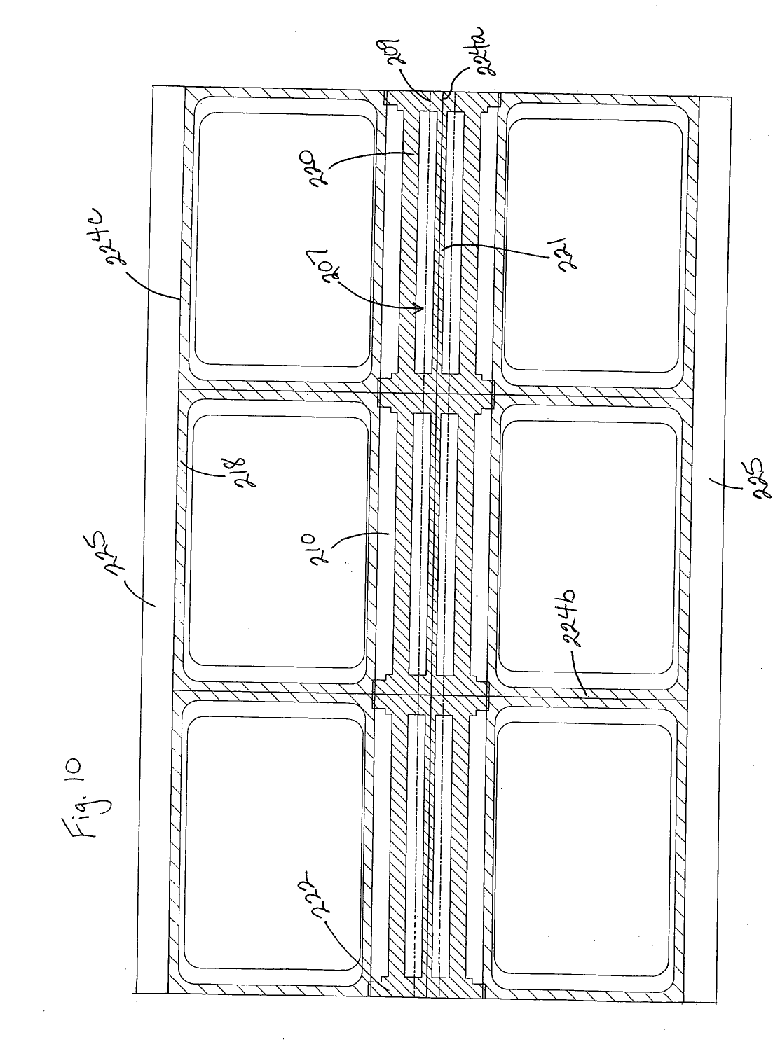

The packaging assembly 200 is similarly constructed as packaging assembly 100 and operates in substantially the same way as packaging assembly 100. The packaging assembly 200 is shown in FIGS. 6, 9, and 10. The packaging assembly 200 includes a plurality of single packages 201 interconnected for the ease of manufacture. The single packages 201 are separated by cutting along lines 224a, 224b, and 224c which represent where the packaging assembly 200 is cut to allow for the separation of each package 201. A single package 201 is shown in FIG. 7. Each package 201 includes a top portion 226, sides 227, and a bottom portion 228. A row of packages 201 are interconnected proximate the sides 227 of the packages 201, and two rows of packages 201 are interconnected proximate the top portions 226 of the packages 201. A machining flange 225 is connected along the bottom portions 228 of the packages 201. Lines 224c along the bottom portions of the single packages 201 represent where the machining flanges 225 are separated from the bottom portions 228 of the single packages 201, line 224a between the top portions 226 of the single packages 201 proximate the longitudinal axis of the packaging assembly 200 represents where the two rows of packages 201 are separated, and lines 224b between the side portions 227 of the single packages 201 represent where the adjacent packages 201 are separated.

Each package 201 includes an upper web 202 and a lower web 203. The upper and lower webs 202 and 203 are preferably flexible packaging film, which is well known in the art. More preferably, the upper web 202 is a non-forming film with an easy-peel layer and the lower web 203 is a forming film. An easy-peel layer is well known in the art, and it is a layer in the film that allows the two layers of web to be separated after they have been heat sealed together. The easy-peel layer creates a weakened bond between the two layers of web. The lower web 203 includes a compartment portion 204 in which foods are contained and a flange portion 205 to which the upper web 202 is operatively connected proximate a perimeter 206 of the upper web 202 and the single package 201. The flange portion 205 is preferably larger proximate the top portion 226 of each package 201.

The perimeter 206 of the upper web 202 and the flange portion 205 of the lower web 203 are releasably interconnected by several seals, preferably heat seals of the easy-open or peel-away type. Releasably interconnecting two layers of web with a heat seal of the easy-open or peel-away type is well known in the art. A seal 218 is placed proximate the sides 227 and the bottom portion 228 of each package 201, and a seal 221 is placed proximate the top portion 226 of each package 201.

Preferably, proximate the seal 221 is a score line 209 along the top portion 226 of each package 201. The score line 209 is preferably a plurality of laser scored perforations in at least one of the two layers of web that do not fully penetrate the at least one of the two layers of web. The score line 209 enables the package 201 to be easily torn open along the score line 209 thereby allowing the two layers of web 202 and 203 to be separated and allowing access to the compartment portion 204. Preferably, the lower web 203 is laser-scored with a plurality of perforations. If both layers of web 202 and 203 include score lines 209, a portion of the top portion 226 may be detached and removed when the package 201 is torn open along the score line 209. The seal 221 functions as a tamper resistant seal before the score line 209 is torn. Optionally, a scissors could be used to cut the package 201 along the top portion 226 or oriented forming film including a notch proximate the top portion 226 could be used to indicate where the package 201 can be torn along the top portion 226 to open the package 201. It is recognized that any suitable means for opening the package 201 proximate the top portion 226 of the package 201 could be used.

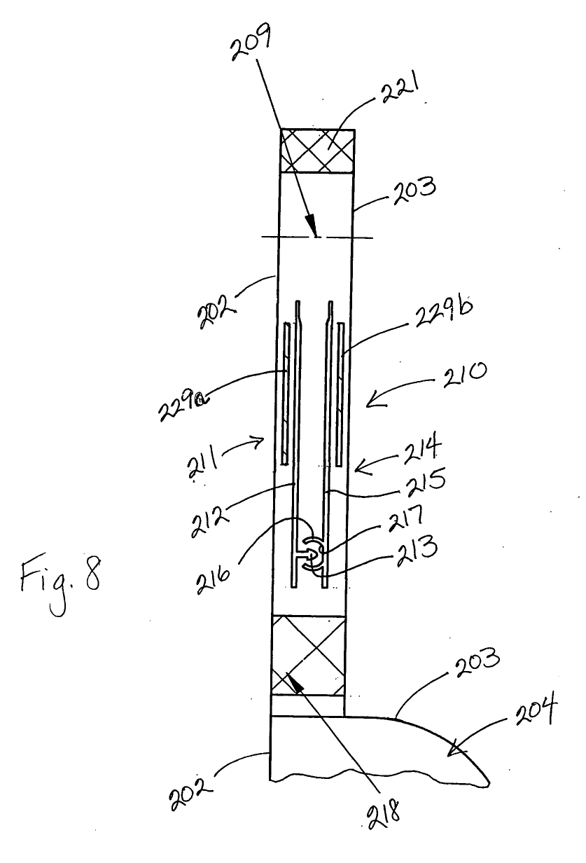

An optional closure 210 proximate the score line 209 is used to releasably interconnect the upper web 202 and the lower web 203 along the top portion 226 of the package 201 when the package 201 has been opened. The closure 210 is preferably an interlocking closure, commonly referred to as a zipper member, a cross section of which is shown in FIG. 8. The closure 210 includes a male portion 211 and a female portion 214. Although it does not matter to which layer of web the male portion 211 and the female portion 214 are operatively connected, the male portion 211 is shown operatively connected to the upper web 202 with heat seal 229a and the female portion 214 is shown operatively connected to the lower web 203 with heat seal 229b.

The male portion 211 includes a connector 212 which operatively connects the male portion 211 to the upper web 202, and the female portion 214 includes a connector 215 which operatively connects the female portion 214 to the lower web 203. The respective portions of the closure 210 are preferably operatively connected to the web with heat seals as is well known in the art. The male portion 211 includes a plug member 213, similar to the plug member 113, having an arrow like cross section extending outward from the connector 212. The female portion 214, similar to female portion 114, includes a plug receiver 216 and a cavity 217. The female portion 214 mates with the male portion 211 similar to how female portion 114 mates with male portion 111. Seal 222 is used to secure the ends of the closure 210 to the sides 227 of the package 201 so that when the closure 210 is sealed the package 201 is also sealed.

An annular head space 207 is formed between the upper web 202 and the lower web 203 and between the seal 221 and the closure 210. The score line 209 is placed within the annular head space 207, and a seal 220 is also placed within the annular head space 207 below the score line 209. The seal 220 preferably does not extend all the way up to the score line 209 so that the upper web 202 and the lower web 203 remain disconnected just below the score line 209. This enables the upper web 202 and the lower web 203 to be grasped and pulled apart in order to break the seal 220 and separate the layers to open the package 201. Each package 201 is hermetically sealed with the seals 218 and 220.

An optional aperture 223 may be used as a peg hole for displaying the package 201. Preferably, the aperture 223 is placed within the seal 220 to ensure the package 201 is sealed. An additional heat seal may be placed proximate the circumference of the aperture 223 to ensure the package 201 is sealed. Because the closure 210 is located below the aperture 223, the aperture 223 does not interfere with the operation of the closure 210. An additional optional seal 218a may be placed between the closure 210 and the compartment portion 204, which is useful to reduce the amount of purge in contact with the closure 210 before the package 201 has been opened. Optional seal 218a is disclosed in U.S. Pat. No. 4,782,951, which is hereby incorporated by reference herein.

To initially open the package 201, the package 201 is preferably torn along the score line 209 thereby allowing the two layers of web 202 and 203 to be separated proximate the score line 209. Each layer of web 202 and 203 is pulled away from the other thereby pulling apart the seals 219 and 220. The seals 219 and 220 are peelable seals. The closure 210 is pulled apart, and then the seal 218a is pulled apart. The seal 218a is also a peelable seal. The compartment portion 204 is then accessible through an opening between the two layers of web 202 and 203 proximate the top portion 226 of the package 201. The package may be re-sealed by mating the male portion 211 and the female portion 214 of the closure 210 together. To subsequently open and re-seal the package, the closure 210 is simply separated and then re-sealed.

### EXAMPLE 1

Two layers of web, each having a thickness of approximately 5 mil, were run on a Multivac R530 machine manufactured by Multivac, Inc. of Kansas City, Mo. using SF-12 specification qualifications. The Multivac R350 machine is a horizontal, thermo-form, fill, and seal machine. The upper web (Part No. M-4656 manufactured by Alcan Inc. of Montreal, Canada) was a non-forming, high barrier film incorporating an easy-peel layer in the film. The lower web (Part No. Z-4878 manufactured by Alcan Inc. of Montreal, Canada) was a forming, high barrier and thermo-formable film that was laser-scored along the top portion of the film to provide easy access into the sealed package. The closure was a Minigrip ZIP-PAK closure, Part No. 612, manufactured by ITW of Orangeburg, N.Y.

The process used intermittent motion. The lower web was transferred from a roll through the Multivac R530 machine in a linear, horizontal fashion. As the lower web advanced, the lower web was heated in the station referred to as the “forming station” to create the compartment portion in each package. The compartment portions are pockets for the foods in the lower web. The lower web is heated using forming temperatures of 80 to 95° F. for 1 to 2 seconds, and the lower web is then stretched to form the compartment portion in approximately 2 to 4 seconds.

As the lower web advanced through the Mulitvac R530 machine, the foods were transferred into the compartment portion of the lower web of each package. As the filled compartment portions advanced, the female portion of the closure was fed from a roll into the Multivac R530 machine in the station referred to as “Preseal 1”. In Preseal 1, the lower web and the female portion of the closure were heat sealed together above the filled compartment portion at 120 to 130° F. for approximately 1 second. As the filled compartment portion and the female portion advanced, they proceeded to the next station referred to as “Preseal 2”.

During Preseal 2, the upper web and the male portion of the closure were heat sealed together and the seal along the top portion of the package between the closure and the laser-scored perforations that sealed the two layers of web together was applied. The upper web was sealed to the male portion of the closure in the station known as the “package header” station. The package header is the area proximate the top of the packaging containing the closure. The upper web was transferred from a roll through the Multivac R530 machine in a linear, horizontal fashion. As the upper web advanced through the Mulitvac R530 machine, the male portion of the closure was fed from a roll into the Multivac R530 machine. The upper web and the male portion of the closure were heat sealed together proximate the top portion of the upper web. The seal along the top portion of the package between the closure and the laser-scored perforations was called the “peg hole seal” and was also created in Preseal 2. To seal the upper web and the lower web together, a temperature of 135 to 145° F. was applied to the lower web and a temperature of 120 to 130° F. was applied to the upper web for approximately 0.7 second in Preseal 2.

After Preseal 2, the upper web and the lower web advance to the station referred to as the “Seal Die”. During the Seal Die, the perimeters of each package were heat sealed after the packages were evacuated of air and either replaced with an inert gas such as nitrogen or carbon dioxide, referred to as a modified atmosphere package system, or held in a vacuum, referred to as a vacuum packaging. The packages were heat sealed for 1.5 to 3 seconds at 125 to 140° F. As the packages advanced, peg holes were punched in the packages proximate the top portions of the packages. The packages were separated in the longitudinal direction and then in the transverse direction. After the packages were separated, the individual packages exited the Multivac R530 machine at approximately 0.1 second per package.

Example 1 is provided for illustrative purposes only as it is recognized that many modifications to the process may be made. For example, heat seals are well known in the art, and it is well known in the art that the temperatures and the times used to form the heat seals is largely dependent upon the types of materials used for the packaging.

The packaged foods are further processed with HPP using water as the pressure medium. The packages are able to withstand up to approximately 87,000 psi of pressure placed on the packages by water at approximately 50 to 60° F. for 2 to 12 minutes without allowing water to enter the packages. Several components of the packages prevent water from penetrating the packages during the HPP process. The laser-scored score lines or perforations do not fully extend through the web thereby preventing water from penetrating through the score lines or perforations. The heat seal between the laser-scored score lines or perforations and the closure reduces the area between the two layers of web within the annular head space of the package where they are not sealed together thereby reducing the space in which water could get trapped. Placing the peg hole or the score line for the punch through peg hole within this heat seal also reduces the chance of water penetrating the package. In addition, if a peg hole is used, the optional heat seal proximate the circumference of the peg hole prevents water from entering the annular head space through the peg hole. Further, a seal below the zipper may be used to prevent purge from the foods from getting trapped between the two layers of web proximate the closure, which may give a displeasing appearance.

By preventing water from penetrating the package during HPP, a more aesthetically pleasing product is displayed for consumers. In addition, the risk of contamination of the foods contained within the package by contaminated water trapped within the annular head space of the package is reduced thereby providing a more healthy product.

The above specification, examples and data provide a complete description of the manufacture and use of the composition of the invention. Since many embodiments of the invention can be made without departing from the spirit and scope of the invention, the invention resides in the claims hereinafter appended.

1. A product packaging for use with high pressure pasteurization processing, comprising:
a) an upper web and a lower web each having a perimeter and a top portion;
b) a first seal connecting the upper web and the lower web proximate the perimeters, the first seal releasably sealing the perimeters of the upper web and the lower web together;
c) a zipper member having a first portion and a second portion, the first portion and the second portion mating with one another and being releasably connectable, the first portion being operatively connected to the top portion of the upper web and the second portion being operatively connected to the top portion of the lower web, the zipper member interconnecting the top portions of the upper web and the lower web;
d) an annular head space between the upper web and the lower web and between the first seal and the zipper member;
e) an area across the top portion of at least one of the upper web and the lower web proximate the annular head space, the area indicating where the at least one of the upper web and the lower web is to be opened; and
f) the first seal prevents moisture from entering the annular head space during high pressure pasteurization.

2. The product packaging of claim 1, further comprising a second seal connecting the upper web and the lower web between the zipper member and the area, the second seal releasably sealing the upper web and the lower web together.

3. The product packaging of claim 1, further comprising:
a) a score line extending along the area across the top portion of at least one of the upper web and the lower web proximate the annular head space, the score line being sealed and allowing the at least one of the upper web and the lower web to be torn along the score line; and
b) the first seal and the score line prevent moisture from entering the annular head space during high pressure pasteurization.

4. The product packaging of claim 3, further comprising a second seal connecting the upper web and the lower web between the zipper member and the score line, the second seal releasably sealing the upper web and the lower web together.

5. The product packaging of claim 1, further comprising a peg hole proximate the annular head space and a third seal connecting the upper web and the lower web about the peg hole, the third seal releasably sealing the upper web and the lower web together, the third seal preventing water from entering the annular head space during high pressure pasteurization.

6. The product packaging of claim 1, further comprising a fourth seal connecting the upper web and the lower web proximate below the zipper member, the fourth seal releasably sealing the upper web and the lower web together, the fourth seal preventing purge from entering the annular head space.

7. A product packaging for use with high pressure pasteurization processing, comprising:
a) an upper web and a lower web each having a perimeter and a top portion;
b) a first seal connecting the upper web and the lower web proximate the perimeters the first seal releasably sealing the perimeters of the upper web and the lower web together;
c) a zipper member having a first portion and a second portion, the first portion and the second portion mating with one another and being releasably connectable, the first portion being operatively connected to the top portion of the upper web and the second portion being operatively connected to the top portion of the lower web, the zipper member interconnecting the top portions of the upper web and the lower web,
d) an annular head space between the upper web and the lower web and between the first seal and the zipper member;
e) a score line extending across the top portion of at least one of the upper web and the lower web proximate the annular head space, the score line being sealed and allowing the at least one of the upper web and the lower web to be torn along the score line; and
f) the first seal and the score line prevent moisture from entering the annular head space during high pressure pasteurization.

8. The product packaging of claim 7, further comprising a peg hole proximate the annular bead space and a third seal connecting the upper web and the lower web about the peg hole, the third seal releasably sealing the upper web and the lower web together, the third seal preventing water from entering the annular head space during high pressure pasteurization.

9. The product packaging of claim 7, further comprising a second seal connecting the upper web and the lower web between the zipper member and the score line, the second seal releasably sealing the upper web and the lower web together.

10. The product packaging of claim 7, a fourth seal connecting the upper web and the lower web proximate below the zipper member, the fourth seal releasably sealing the upper web and the lower web together, the fourth seal preventing purge from entering the annular head space.

11. A method of packaging a product and treating the packaged product with high pressure pasteurization, comprising:
a) placing a product within a package being water resistant;
b) submerging the packaged product in water and applying pressure on the packaged product with water; and
c) removing the packaged product from the water, wherein the packaged product has not been penetrated by water.

12. The method of claim 11, the package comprising an upper web and a lower web each having a perimeter and a top portion, a first seal connecting the upper web and the lower web proximate the perimeters, the first seal releasably sealing the perimeters of the upper web and the lower web together, a zipper member having a first portion and a second portion, the first portion and the second portion mating with one another and being releasably connectable, the first portion being operatively connected to the top portion of the upper web and the second portion being operatively connected to the top portion of the lower web, the zipper member interconnecting the top portions of the upper web and the lower web, an annular bead space between the upper web and the lower web and between the first seal and the zipper member, a score line extending across the top portions of the upper web and the lower web proximate the annular head space, the score line being sealed and allowing the upper web and the lower web to be torn along the score line, the first seal and the score line prevent moisture from entering the annular head space during high pressure pasteurization.

13. The method of claim 12, the package further comprising a second seal connecting the upper web and the lower web between the zipper member and the score line, the second seal releasably sealing the upper web and the lower web together.

14. The method of claim 12, the package further comprising a peg hole proximate the annular head space and a third seal connecting the upper web and the lower web about the peg hole, the third seal releasably sealing the upper web and the lower web together, the third seal preventing water from entering the annular head space during high pressure pasteurization.

15. The method of claim 12, the package further comprising a fourth seal connecting the upper web and the lower web proximate below the zipper member, the fourth seal releasably sealing the upper web and the lower web together, the fourth seal preventing purge from entering the annular head space.

16. A method of packaging a product and treating the packaged product with high pressure pasteurization, comprising:
a) placing a product within a package being water resistant, the package including an upper web and a lower web each having a perimeter and a top portion, a first seal connecting the upper web and the lower web proximate the perimeters, the first seal releasably sealing the perimeters of the upper web and the lower web together, a zipper member having a first portion and a second portion, the first portion and the second portion mating with one another and being releasably connectable, the first portion being operatively connected to the top portion of the upper web and the second portion being operatively connected to the top portion of the lower web, the zipper member interconnecting the top portions of the upper web and the lower web, an annular head space between the upper web and the lower web and between the first seal and the zipper member, a score line extending across the top portions of the upper web and the lower web proximate the annular head space, the score line being sealed and allowing the upper web and the lower web to be torn along the score line, the first seat and the score line prevent moisture from entering the annular head space during high pressure pasteurization;
b) submerging the packaged product in water and applying pressure on the packaged product with water; and
c) removing the packaged product from the water, wherein the packaged product has not been penetrated by water.

17. The method of claim 16, the package further comprising a second seal connecting the upper web and the lower web between the zipper member and the score line, the second seal releasably sealing the upper web and the lower web together.

18. The method of claim 16, the package further comprising a peg hole proximate the annular head space and a third seal connecting the upper web and the lower web about the peg hole, the third seal releasably sealing the upper web and the lower web together, the third seal preventing water from entering the annular head space during high pressure pasteurization.

19. The method of claim 16, the package further comprising a fourth seal connecting the upper web and the lower web proximate below the zipper member, the fourth seal releasably sealing the upper web and the lower web together, the fourth seal preventing purge from entering the annular head space.

20. A product packaging for use with high pressure pasteurization processing, comprising:
a) an upper web and a lower web each having a perimeter and a top portion;
b) a first seal connecting the upper web and the lower web proximate the perimeters;
c) a closure having a first portion and a second portion, the first portion and the second portion mating with one another and being releasably connectable, the first portion being operatively connected to the top portion of the upper web and the second portion being operatively connected to the top portion of the lower web, the closure releasably interconnecting the top portions of the upper web and the lower web;
d) an annular head space between the upper web and the lower web and between the first seal and the closure;
e) an area across the top portion of at least one of the upper web and the lower web proximate the annular head space, the area indicating where the at least one of the upper web and the lower web is to be opened; and
f) the first seal prevents moisture from entering the annular head space during high pressure pasteurization.

21. The product packaging of claim 20, wherein the first seal releasably seals the perimeters of the upper web and the lower web together.

22. The product packaging of claim 20, wherein the closure is a zipper member.

23. The product packaging of claim 22, wherein the zipper member is a press to close zipper member.

24. The product packaging of claim 20, further comprising a second seal connecting the upper web and the lower web between the closure and the area, the second seal releasably sealing the upper web and the lower web together.

25. The product packaging of claim 20, further comprising:
a) a score line extending along the area across the top portion of at least one of the upper web and the lower web proximate the annular head space, the score line being sealed and allowing the at least one of the upper web and the lower web to be torn along the score line; and
b) the first seal and the score line prevent moisture from entering the annular head space during high pressure pasteurization.

26. The product packaging of claim 25, further comprising a second seal connecting the upper web and the lower web between the closure and the score line, the second seal releasably sealing the upper web and the lower web together.

27. The product packaging of claim 20, further comprising a peg hole proximate the annular head space and a third seal connecting the upper web and the lower web about the peg hole, the third seal releasably sealing the upper web and the lower web together, the third seal preventing water from entering the annular head space during high pressure pasteurization.

28. The product packaging of claim 20, further comprising a fourth seal connecting the upper web and the lower web proximate below the closure, the fourth seal releasably sealing the upper web and the lower web together, the fourth seal preventing purge from entering the annular head space.

29. The product packaging of claim 1, wherein the zipper member is a press to close zipper member.

30. The product packaging of claim 7, wherein the zipper member is a press to close zipper member.

31. The method of claim 12, the zipper member being a press to close zipper member.

32. The method of claim 16, the zipper member being a press to close zipper member.
